(19) United States
(12) Patent Application Publication
(10) Pub. No.: US 2008/0041966 A1
(43) Pub. Date: Feb. 21, 2008

(54) Mid-Seam Package Methods of Manufacture for Memory Cards Using Ultraviolet Cure Adhesive and Ultra-Sonic Press

(75) Inventors: Siew Sin Hiew, San Jose, CA (US); Nan Nan, San Jose, CA (US); Abraham Chih-Kang Ma, Fremont, CA (US); Jim Chin-Nan Ni, San Jose, CA (US); Ming-Shiang Shen, Taipei Hsien (TW)

Correspondence Address: LAW OFFICES OF IMAM, 111 N. MARKET STREET, SUITE 1010, SAN JOSE, CA, 95113, US

(73) Assignee: Super Talent Electronics, Inc., San Jose, CA (US)

(21) Appl. No.: 11/851,336

(22) Filed: Sep. 6, 2007

Related U.S. Application Data
(63) Continuation-in-part of application No. 10/888,282, filed on Jul. 8, 2004.
(63) Continuation-in-part of application No. 10/913,868, filed on Aug. 6, 2004, now Pat. No. 7,264,992.
(63) Continuation-in-part of application No. 11/071,289, filed on Mar. 3, 2005, now Pat. No. 7,174,628.
(63) Continuation-in-part of application No. 11/466,759, filed on Aug. 23, 2006.
Application No. 11/466,759 is a continuation-in-part of application No. 09/478,720, filed on Jan. 6, 2000, now Pat. No. 7,257,714.
Application No. 11/466,759 is a continuation-in-part of application No. 10/761,853, filed on Jan. 20, 2004.
Application No. 11/466,759 is a continuation-in-part of application No. 10/789,333, filed on Feb. 26, 2004, now Pat. No. 7,318,117.

(51) Int. Cl. G06K 19/06; H01R 43/00

(52) U.S. Cl. 235/492; 29/825

(57) ABSTRACT

In an embodiment of the present invention, the hollow shell of a mid-seam memory card is composed of three, independently formed, plastic pieces—a bottom plastic piece, a top plastic piece, and a plastic lid. The plastic pieces are cross-linked using, for example, ultraviolet light (UV) activated epoxy, or ultrasonic-press methods. A printed circuit board (PCB) assembly, including memory, is positioned within the cavity of the plastic pieces, and the lid is attached. The PCB assembly can be made using chip on board (COB) or surface mount technology (SMT) components attached using ball grid array (BGA) or thin and small outline package (TSOP) connections. Various read-write/write-protect devices are possible, and can be implemented in the form of a physical feature present on one of the lateral sides of the bottom and top plastic pieces. Such devices allow the card to be read from, or written to, when in read-write mode; and upon action by the user, cause the card to function in a write-protect mode, where no more information can be written to the card's memory. These devices may be manifested as dynamic switches, removably connectible plugs, or permanently removable fin-structures.

### CROSS REFERENCE TO RELATED APPLICATIONS

This application is a continuation-in-part of U.S. patent application Ser. No. 10/888,282 filed on Jul. 8, 2004, and entitled “MANUFACTURING METHOD FOR MEMORY CARD”; a continuation-in-part of U.S. patent application Ser. No. 10/913,868 filed on Aug. 6, 2004, and entitled “REMOVABLE FLASH INTEGRATED MEMORY MODULE CARD AND METHOD OF MANUFACTURE”; a continuation-in-part of U.S. Pat. No. 7,174,628 B1, filed Feb. 13, 2007, and entitled “MEMORY CARD PRODUCTION USING PREFABRICATED COVER AND MOLDED CASING PORTION”; a continuation-in-part of U.S. patent application Ser. No. 11/466,759, filed Aug. 23, 2006, and entitled “FLASH MEMORY CONTROLLER FOR ELECTRONIC DATA FLASH CARD” which is a continuation-in-part of U.S. patent application Ser. No. 09/478,720, filed Jan. 6, 2000, and entitled “ELECTRONIC DATA STORAGE MEDIUM WITH FINGERPRINT VERIFICATION CAPABILITY”; a continuation-in-part of U.S. patent application Ser. No. 10/761,853, filed Jan. 20, 2004, and entitled “HIGHLY INTEGRATED MASS STORAGE DEVICE WITH AN INTELLIGENT FLASH CONTROLLER”; and a continuation-in-part of U.S. application Ser. No. 10/789,333, filed Feb. 26, 2004, and entitled “SYSTEM AND METHOD FOR CONTROLLING FLASH MEMORY”, the disclosures of which are incorporated herein by reference as though set forth in full.

### BACKGROUND OF THE INVENTION

1. Field of the Invention

The present invention relates generally to the field of chip on board (COB) and surface mount technology (SMT) memory cards, and particularly to a method for manufacturing memory cards using ultraviolet light (UV) activated epoxy.

2. Description of the Prior Art

As computers have gained enormous popularity in recent decades, so has the need for better and more efficient ways of storing memory. Notable among memory devices are the portable ones such as memory cards that may be carried around by the user to access their information at different locations. For other electronic devices such as iPods, Personal Digital Assistants (PDA), Digital cameras/camcorders, and cellular phones, memory cards are also used for storing of information. This is particularly common in the case of personal computers (PC) where the need often arises to transfer data from one PC to another. Examples of portable memory devices include nonvolatile memory devices such as secure digital cards (SD) that are removably connectible to a computer.

Physical size limitations, due to industry standards that must be met regarding total package size of the memory card, place restrictions on the outer dimensions of the memory card. Ultimately, this can result in capacity limitations.

Thus, it is desirable to manufacture a memory card that where the outer package assembly is more efficiently designed so that the internal electronics are given more physical space, and thus memory capacity can be increased, allowing users to store increasing amounts of information within. Assembly of a mid-seam memory card using techniques such as ultraviolet light epoxy and ultrasonic-press, combined with smaller footprint electronic components, such as those employing ball grid array connectors, better allows such benefits to be realized. In addition, the memory card should have a low cost of manufacturing, with an improved aesthetic quality, to appeal to a wide range of potential users.

### SUMMARY OF THE INVENTION

Briefly, an embodiment of the present invention includes a memory card having a bottom plastic piece and a top plastic piece, both with a plurality of lateral sides, and a cavity interposed along the lateral sides of both plastic pieces when permanently joined. The bottom and top plastic pieces are cross-linked, and a printed circuit board (PCB) assembly, including memory, is positioned in the cavity. A third plastic piece is then positioned as a lid, or alternatively, created by an injection molding step. Cross-linking of the plastic pieces can be done using various technologies, such as ultraviolet light (UV) activated epoxy, or ultrasonic-press methods.

Various read-write protection devices can be implemented through the modification of one of the said lateral sides. Such devices may be embodied as dynamically located switches, permanently removable fins, or removably connectible caps. Switches are attached to the card after the manufacturing process, as a final assembly step; and depending on their user-selectable position within the read-write/write-protect notch-region, cause the card to function in either read-write or write-protect mode. Fins, made during the manufacturing process of the top and bottom plastic pieces, are located in the read-write/write-protect notch-region of the memory card and cause the memory card to function in read-write mode when the fins are present, and in write-protect mode when the fins are removed by the user, and the notch is exposed. Alternatively, a removable cap is inserted into a notch, configuring the card to function in a read-write mode when the cap is present in the notch, and in a write-protect mode when the notch is exposed.

The foregoing and other objects, features, and advantages of the present invention will be apparent from the following detailed description of the preferred embodiments, which make reference to several figures of the drawings.

### IN THE DRAWINGS

FIG. 1(a) shows an angular view of memory card 10.

FIG. 1(b) shows a top view of memory card 10.

FIG. 1(c) shows a bottom view of memory card 10.

FIG. 2(a) shows an exploded view of the casing components of memory card 10.

FIG. 2(b) is a side-view showing the alignment of top plastic piece 12 and bottom plastic piece 11 for creation of sub-assembly 25.

FIG. 2(c) shows a rear-angular view of sub-assembly 25 of memory card 10.

FIG. 2(d) is a cross-sectional side view of sub-assembly 25 and shoe-shaped cavity 26.

FIG. 3(a) shows an angular view of memory card 30, an alternative embodiment of the present invention.

FIG. 3(b) shows an exploded view of memory card 30.

FIG. 4 shows a bottom angular view of printed circuit board assembly (PCBA) 40.

FIG. 5(a) shows a top view of chip on board (COB) PCBA 50.

FIG. 5(b) shows a top view of surface mounted technology (SMT) PCBA 54.

FIG. 6(a) shows PCBA 50 being inserted into shoe-shaped cavity 26.

FIG. 6(b) shows PCBA 50 being positioned within shoe-shaped cavity 26.

FIG. 7 shows an exploded view of completed memory card 10.

FIG. 8(a) shows memory card 80, with dynamic read-write/write-protect switch 84, an alternative embodiment of the present invention.

FIG. 8(b) shows memory card 85, with ribbed edge 86 instead of a read-write/write-protect mechanism, an alternative embodiment of the present invention.

FIG. 8(c) shows memory card 87, with ribbed edge 89 and smooth edge 89 instead of a read-write/write-protect mechanism, an alternative embodiment of the present invention.

### DETAILED DESCRIPTION OF THE PREFERRED EMBODIMENTS

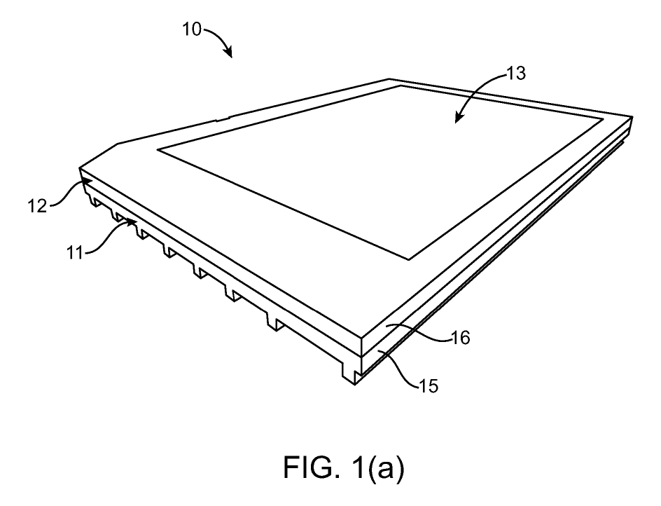

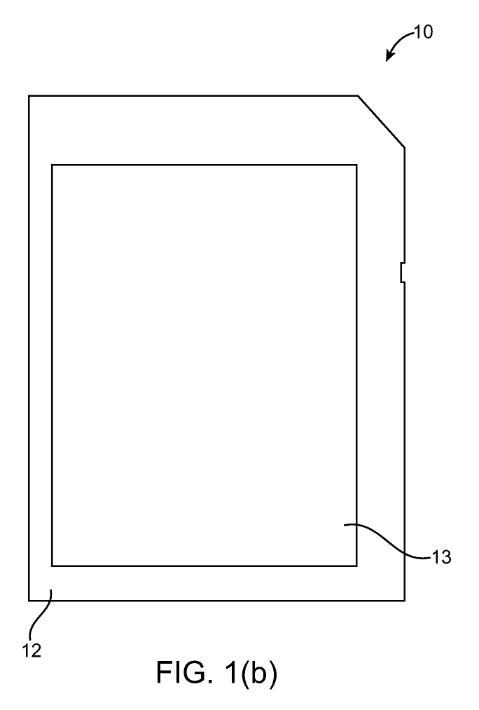

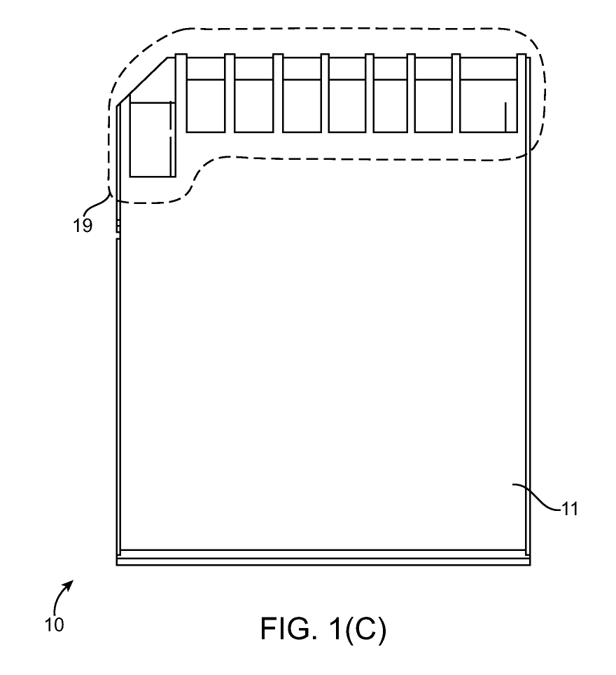

Referring now to FIG. 1(a), an angular view of assembled memory card 10 is shown to include bottom plastic piece 11, top plastic piece 12, and lid 13, which are visible. Bottom plastic piece 11 and top plastic piece 12 are situated in the final assembly of memory card 10, so that one lies on top of the other, and each pieces' plurality of lateral sides are aligned with the corresponding lateral sides on the other plastic piece. For example, lateral side 15 of bottom plastic piece 11 is aligned with corresponding lateral side 16 of top plastic piece 12. Lid 13 is inserted into hole 24 of top plastic piece 12, as will be further explained shortly.

FIG. 1(b) shows a top view of lid 13 and top plastic piece 12, of memory card 10. In an embodiment of the present invention, the dimensions of top plastic piece 12 and bottom plastic piece 11 are the same, such that when memory card 10 is viewed directly from the top or bottom, with the pieces properly aligned, only one of either top plastic piece 12 or bottom plastic piece 11 is visible. In an embodiment of the present invention, plastic lid 13 is located substantially in the center of top plastic piece 12, and is surrounded on all four sides by top plastic piece 12; however, in other embodiments lid 13 may be located less centrally to lid 12, or be unbounded on one or more sides by top plastic piece 12.

FIG. 1(c) shows a bottom view of memory card 10, where top plastic piece 12 is fully obstructed from view by bottom plastic piece 11. Multi-pin connector 19 interfaces memory card 10 with a host device and facilitates the transfer of information therebetween, as will be discussed in more detail shortly. In the present embodiment of the current invention, multi-pin connector 19 is comprised of eight pins, although other configurations, with more or less pins, are possible.

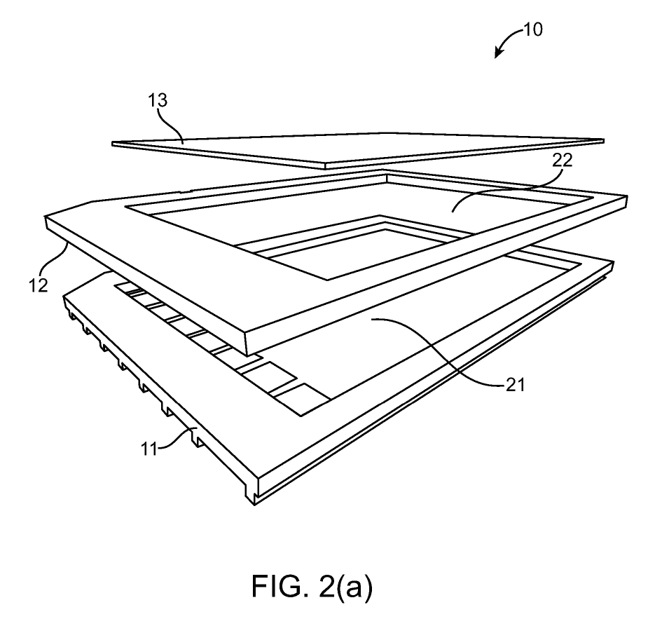

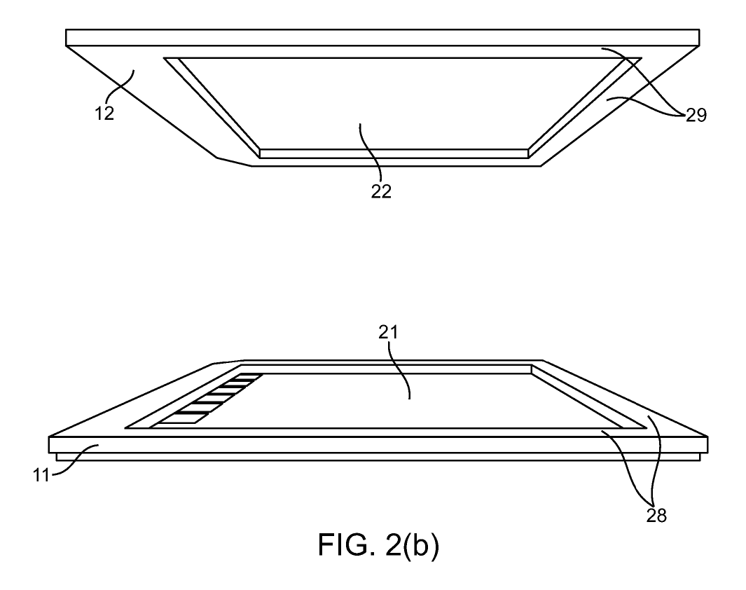

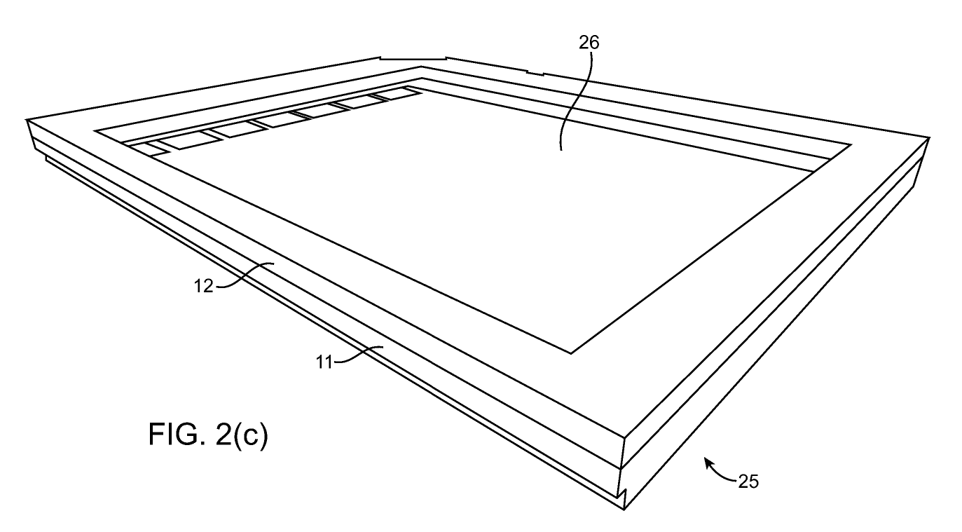

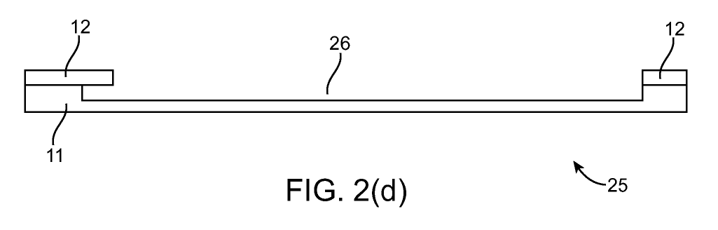

Referring now to FIG. 2(a), an exploded view of bottom plastic piece 11, top plastic piece 12, and lid 13 of memory card 10 is shown. Bottom plastic piece 11, top plastic piece 12, and lid 13 are each created by separate processes. Such processes may be, for example, independent auto-mold or injection-molding steps. The final assembly of memory card 10 is such that bottom plastic piece 11 and top plastic piece 12 are situated directly above/beneath each other, and lid 13 is used to seal rectangular hole 22, creating a cavity within.

FIG. 2(b) further illustrates how bottom plastic piece 11 and top plastic piece 12 are permanently cross-linked to form sub-assembly 25. After pieces 11 and 12 are formed, if an epoxy is to be used to cross-link pieces 11 and 12, it is dispensed on top face 28 of bottom plastic piece 11, or bottom face 29 of top plastic piece 12, or both. If the epoxy to be used is ultraviolet light activated epoxy (UV epoxy), then at least one of the plastic pieces (11 or 12) must be molded using transparent plastic resin so that light can pass thru, to allow for activation of the UV epoxy.

As shown in FIG. 2(c), top piece 12 and bottom piece 11 are then placed, by machine or by hand, for example, so that faces 29 and 28, and rectangular hole 22 and rectangular cavity 21 respectively, are aligned and adjacent. If UV epoxy is used, UV light is shone on plastic pieces 11 and 12 to activate the epoxy, which cures and cross-links bottom plastic piece 11 to top plastic piece 12, creating a permanent lower sub-assembly 25. FIG. 2(d) shows a cross-sectional view of bottom plastic piece 11 cross-linked to top plastic piece 12, also known as lower sub-assembly 25, whereby shoe-shaped cavity 26 is created from the merging of rectangular hole 22 and rectangular cavity 21. In other embodiments of the present invention, shoe-shaped cavity 26 may have other shapes such as rectangular, parallel-piped, or cubic; hole 22 and cavity 21 may also have other shapes, such as rounded, or any geometric shape with three or more sides.

In an alternative embodiment of the present invention, ultrasonic-press is used to cross-link bottom plastic piece 11 to top plastic piece 12. If ultrasonic-press is used, instead of UV epoxy, the use of a transparent plastic resin for creating any of the plastic pieces is no longer necessary, as light does not need to reach interface of faces 28 and 29. Instead, bottom plastic piece 11 and top plastic piece 12 are placed so that the corresponding lateral sides (i.e. lateral sides 15 and 16 in FIG. 1(a)) are directly above/beneath each other, and so that bottom face 29 is adjacent and aligned with top face 28, and ultrasonic waves then vibrates pieces 11 and 12 at a high frequency. Because of the vibrations, friction heats and melt faces 29 and 28, causing the plastic pieces to bind, permanently cross-linking pieces 11 and 12 and forming sub-assembly 25.

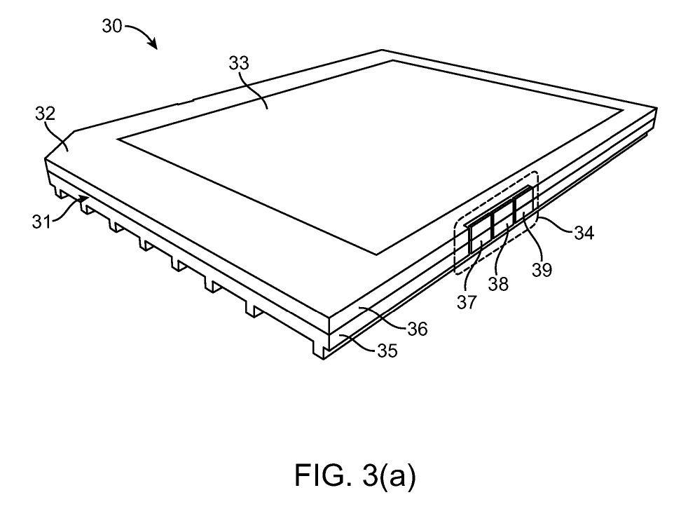

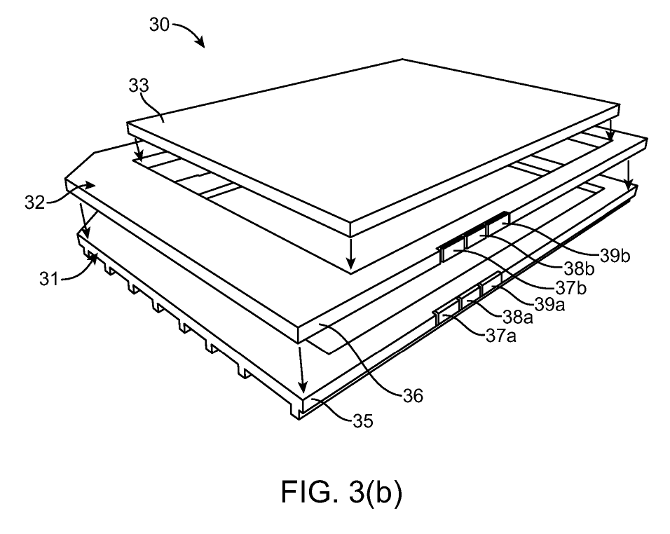

Referring now to FIGS. 3(a) and 3(b), an alternative embodiment of memory card 10 is shown. Memory card 30 contains a read-write/write-protect device—fin-structure 34. Memory card 30 is manufactured with fin-structure 34 in place, and while present, fin-structure 34 allows the user to read from or write to the memory card. When the user desires for memory card 30 to become permanently write-protected, he/she snaps off fin-structure 34, and the host device will no longer allow for the information contained within card 30 to be overwritten. FIG. 3(b) shows that despite the presence of physical structures providing a write-protection method, the interfacing and cross-linking of bottom plastic piece 31 to top plastic piece 32 is the same process of cross-linking bottom plastic piece 11 to top plastic piece 12 in memory card 10. Lid 33 serves the same function, and is cross-linked in the same manner as lid 13, as will be discussed shortly herein.

As seen in FIG. 3(a), fin-structure 34 is composed of three fins—fins 37, 38, and 39. FIG. 3(b) shows that prior to the cross-linking of bottom plastic piece 31 and top plastic piece 32, fin 37 exists as two halves, 37a and 37b; fin 38 exists as two halves, 38a and 38b; and fin 39 exists as two halves, 39a and 39b. Similarly, in alternative embodiments of the present invention, a feature present on one of the plurality of lateral sides, such as a read-write/write-protect mechanism, may not be present entirely on either the bottom or top plastic piece, but may instead start as two separate entities, which subsequent to the cross-linking step, become one solid entity.

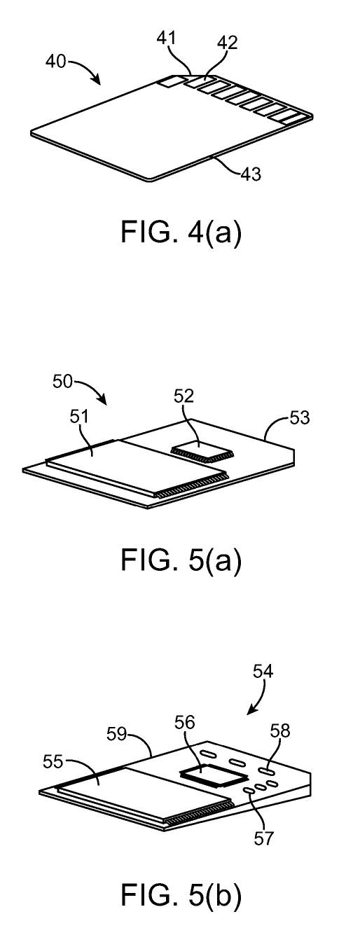

FIG. 4 shows a bottom view of internal printed circuit board (PCB) assembly 40 of a memory card, of any of the embodiments of the present invention. PCB assembly 40 is shown to include decline corner 41 for proper positioning within the bottom plastic piece, and a multi-pin connector 42, on substrate 43, for communicating with the host device. In an embodiment of the present invention, PCB assembly 40 contains the memory, controller, and any other electronic devices necessary for the function of the memory card it is inserted into, as will be discussed shortly. Multi-pin connector 42 is substantially the same as multi-pin connector 19 on memory card 10, as seen in FIG. 1(c), except multi-pin connector 42 is shown as utilizing 9 pins, instead of 8. Multi-pin connector 42 couples the host device to the memory card using a wide range of protocols, examples of which are presented in U.S. Patent Publication No. US2005/0197017 A1, publication date Sep. 8, 2005 entitled, “EXTENDED SECURE DIGITAL (SD) DEVICES AND HOSTS,” the disclosure of which is herein incorporated by reference as though set forth in full. Examples of protocols used to couple the memory card with a host device through interface connector 42 include, but are not limited to, Multi-Media Card (MMC), Serial Peripheral Interface (SPI), Secure Digital (SD), Enhanced Multi-Media Card (EMMC), Universal Serial Bus (USB), Enhanced Universal Serial Bus (EUSB), Peripheral Component Interconnect Express (PCIE), Serial Advanced Technology Attachment (SATA) and the IEEE 1394 interface (also referred to as “firewire”). In other embodiments of the present invention: multi-pin connector 42 may have any number of pins; and decline corner 41 may not be present, or may be present in multiplicity on any number or combination of the corners of substrate 43.

FIG. 5(a) shows a top angular view of internal PCB assembly 50, employing chip on board (COB) electronics. PCB assembly 50 is composed of electronic devices, for example 51 and 52, mounted to substrate 53. Examples of electronic devices include flash memory units, controllers, and passive components. In addition to electronic devices 51 and 52, COB PCB assembly 50 may contain other components, such as passive components for example, such as resistors, capacitors, and inductors.

FIG. 5(b) shows a top angular view of an alternative PCB assembly 54, employing surface mounted technology (SMT) electronics. Assembly 54 is composed of, for example, electronic devices 55 and 56, and passive components 57-58, mounted on substrate 59. Electronic devices 55 and 56 may include, for example, flash memory die or controller die. Passive components 57-58 may include, for example, resistors, capacitors, and inductors. In other embodiments of the present invention, electronic devices 55 and 56, and passive components 57 and 58 can be mounted on both sides, or on the bottom-side of substrate 59.

PCB assemblies 50 and 54 are manufactured independent from the molding steps of the bottom and top plastic pieces. Electronic devices 55 and 56 of PCB Assembly 54 may be attached to substrate 59 using a variety of technologies, using, for example, thin and small outline package (TSOP) or ball grid array (BGA) methods. In either processes, substrate 59 first passes through a stencil printer, printing a layer of solder paste thereon. A pick-and-place machine then mounts electronic devices 55 and 56, and passive components 57-58. After mounting, the PCB assembly passes through an IR-reflow oven which melts the solder, connecting the pins of the substrate 59, electronic devices 55 and 56, and passive components 57-58.

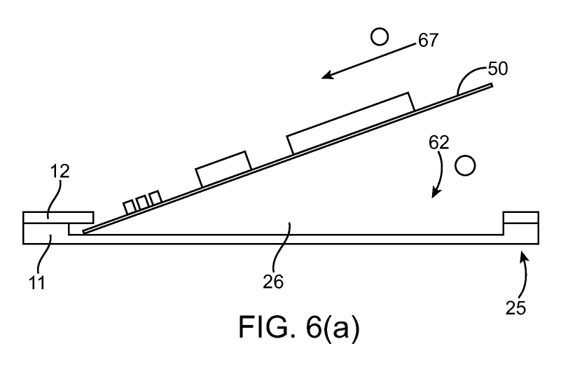

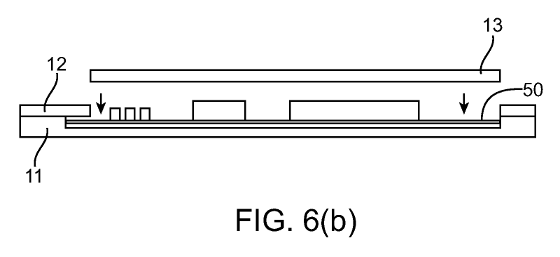

Referring now to FIG. 6(a), PCB assembly 50 is being inserted into shoe-shaped cavity 26 of sub-assembly 25, which is comprised of bottom plastic piece 11 and top plastic piece 12. PCB assembly 50 is first pushed into shoe-shaped cavity 26, by force 61; and is then pushed down by force 62, which ensures that assembly 50 is located snugly between the plurality of lateral sides of bottom plastic piece 11, as can be better seen in FIG. 6(b). Following the full insertion of PCB assembly 50 within shoe-shaped cavity 26, lid 13 is attached.

Lid 13 may be created from a variety of manufacturing methods. In one embodiment of the present invention, lid 13 is created as part of a separate injection-molding or auto-molding step, similar to that of bottom and top plastic pieces 11 and 12; and then attached to top plastic piece 12 using UV epoxy or ultrasonic-press. If UV epoxy is to be used, then either lid 13 or top plastic piece 12 must be molded from a transparent plastic resin in order to ensure that UV light can reach the UV epoxy to activate and cross-link top plastic piece 12 to lid 13. In an alternative embodiment, lid 13 is created as part of an injection molding process, whereby the remaining void of shoe-shaped cavity 26 is filled with molten plastic, which subsequently hardens to form a solid top lid. The glass-transition temperature of the plastic material of lid 13 should be higher than the glass-transition temperature of top plastic piece 12, in order to ensure adequate cross-linking between the two plastic components. In another alternative embodiment, lid 13 is only physically pressed into place, into rectangular hole 22, and frictional forces hold it secure within top plastic piece 12.

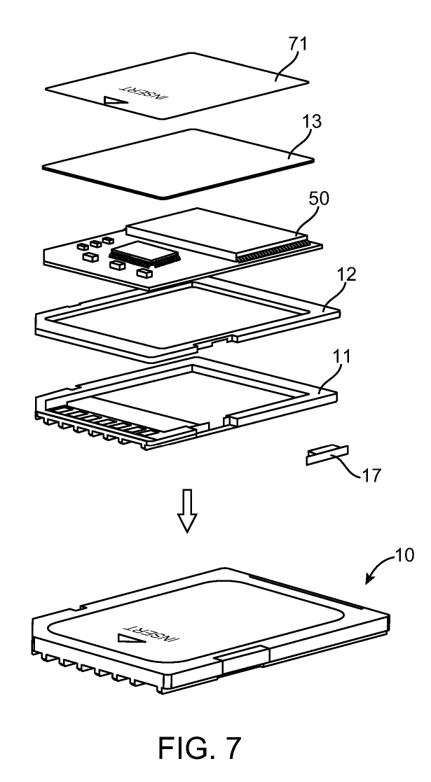

Referring to FIG. 7, an overview of the complete assembly process, of memory card 10, can be seen. In addition to the components mentioned herein prior, label 71 may be affixed to lid 13 of memory card 10, hiding the seam that is created as a result of attaching lid 13, and enhancing the overall aesthetic appeal of memory card 10. In an embodiment of the present invention, label 71 is attached using an adhesive surface on one side, but other methods of attachment are possible. Printed on label 71 may be a custom designed logo and other information. In addition, label 71 enhances moisture and water resistance of the memory card 10 to protect the electronic devices within.

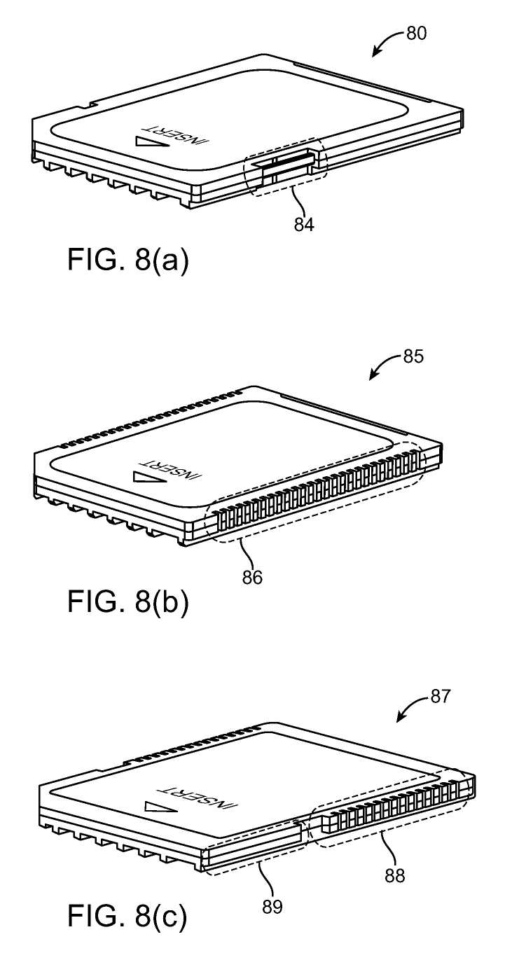

FIGS. 8(a)-8(c) show various alternative sample embodiments of molded bottom plastic piece 11 and molded top plastic piece 12. In FIG. 8(a) the notch-region 15 of memory card 10 has been replaced by a dynamically configurable switch device 84 on memory card 80. Depending upon the position of switch device 84, memory card 80 functions in either read-write, or write-protected mode.

In FIG. 8(b), memory card 85 lacks any read-write/write-protect device, and instead has ribs 86 to provide the user with a surface that assists with insertion of memory card 85 into, and removal of memory card 85 out of, a host device. In FIG. 8(c), memory card 87 combines ribs 88, for easier user handling, with a flattened region 89, for smoother insertion and removal into a host device.

FIGS. 8(a)-8(c) serve to illustrate alternative embodiments of memory cards that can be manufactured using the mid-seam UV-cure or ultrasonic-press methods of manufacturing, and is not intended to be exhaustive of all potential package designs.

Although the present invention has been described in terms of specific embodiment, it is anticipated that alterations and modifications thereof will no doubt become apparent to those more skilled in the art. It is therefore intended that the following claims be interpreted as covering all such alterations and modification as fall within the true spirit and scope of the invention.

What is claimed is:

1. A memory card comprising:
a bottom plastic piece having a plurality of lateral sides, and further having a cavity interposed along said plurality of lateral sides;
a top plastic piece having a plurality of lateral sides corresponding to the plurality of lateral sides of said bottom plastic piece, and further having a hole formed therein along the plurality of lateral sides that substantially aligns with the cavity interposed along the lateral sides of said bottom plastic piece, and is aligned and cross-linked with said bottom plastic piece so that the bottom plastic piece and top plastic piece form a sub-assembly;
a printed circuit board (PCB) assembly, including memory, and positioned in the cavity of said sub-assembly; and
a plastic lid, attached to said top plastic piece, filling said top plastic piece's hole, and covering said PCB assembly.

2. A memory card, as recited in claim 1, wherein the memory card is a secure digital (SD) card.

3. A memory card, as recited in claim 2, wherein a notch is formed on one of the plurality of lateral sides of the sub-assembly.

4. A memory card, as recited in claim 3, wherein a dynamic switch device is in the notch of one of the plurality of lateral sides of the sub-assembly, which, depending on its selectable position, causes the card to operate in either read-write, or write-protect mode.

5. A memory card, as recited in claim 3, wherein the notch includes a clamp-bar into which a read-write plug is placed.

6. A memory card, as recited in claim 3, wherein a read-write plug is insertably positioned into the notch on one of the plurality of lateral sides, where the memory card is configured to function in a read-write mode when the read-write plug is positioned into the notch, and in a write-protect mode when the notch is exposed.

7. A memory card, as recited in claim 6, wherein the read-write plug is a female read-write plug.

8. A memory card, as recited in claim 6, wherein the read-write plug is a male read-write plug.

9. A memory card, as recited in claim 2, wherein a fin-structure is formed on one of the plurality of lateral sides which causes the card to function in read-write mode when present, and to function in write-protect mode when removed.

10. A memory card, as recited in claim 2, wherein the bottom plastic piece is cross-linked to the top plastic piece using ultraviolet light activated epoxy.

11. A memory card, as recited in claim 2, wherein the bottom plastic piece is cross-linked to the top plastic piece using ultrasonic-press.

12. A memory card, as recited in claim 2, wherein the lid is attached to said sub-assembly by activated ultraviolet epoxy.

13. A memory card, as recited in claim 2, wherein the lid is attached to said sub-assembly by ultrasonic press.

14. A memory card, as recited in claim 12, further including a label disposed on top of said lid and sub-assembly to protect the PCB and to provide a seamless appearance thereto.

15. A memory card, as recited in claim 14, wherein the memory card is coupled to a host device to transfer information between said memory card and said host device.

16. A memory card, as recited in claim 15, to further include an interface adapted to couple the memory card to the host device.

17. A memory card, as recited in claim 1, wherein the cavity is rectangular in shape.

18. A method of manufacturing a memory card comprising:
forming a bottom plastic piece having a plurality of lateral sides to form a cavity interposed among said lateral sides;
forming a top plastic piece, having a plurality of lateral sides that corresponds to the plurality of lateral sides of said bottom plastic piece, so as to form a hole interposed among said lateral sides;
aligning said top plastic piece with said bottom plastic piece so that the cavity of said bottom plastic piece substantially aligns with the hole of said top plastic piece, and cross-linking said top plastic piece to said bottom plastic piece to form a sub-assembly;
positioning a printed circuit board (PCB) assembly, including memory, within said sub-assembly; and
positioning a plastic lid within the hole of the top plastic piece so as to cover said PCB assembly.

19. A method of manufacturing, as recited in claim 18, wherein a notch is formed on one of the plurality of lateral sides of the sub-assembly.

20. A method of manufacturing, as recited in claim 19, wherein a dynamic switch device is installed in the notch located on one of the plurality of lateral sides of the sub-assembly, which, depending on its selectable position, causes the card to operate in either read-write or write-protect mode.

21. A method of manufacturing, as recited in claim 19, wherein a read-write plug is removably inserted into the notch on one of said plurality of lateral sides of the memory card, where the memory card is configured to function in read-write mode when the read-write plug is positioned into the notch, and in write-protect mode when the read-write plug is removed and the notch is exposed.

22. A method of manufacturing, as recited in claim 18, wherein a removable fin-structure is formed on one of the lateral sides of the sub-assembly which causes the card to function in read-write mode when present, and upon removal by the user causes the card to function in write-protect mode.

23. A method of manufacturing, as recited in claim 18, wherein the memory card manufactured is a secure digital (SD) card

24. A method of manufacturing, as recited in claim 18, wherein the top plastic piece is cross-linked to the bottom plastic piece using ultraviolet light activated epoxy.

25. A method of manufacturing, as recited in claim 18, wherein the top plastic piece is cross-linked to the bottom plastic piece using ultrasonic-press.

26. A method of manufacturing, as recited in claim 18, wherein the lid is cross-linked to the top plastic piece using ultraviolet light activated epoxy.

27. A method of manufacturing, as recited in claim 18, wherein the lid is cross-linked to the top plastic piece using ultrasonic-press.
